(19) United States
(12) Patent Application Publication
(10) Pub. No.: US 2016/0101536 A1
(43) Pub. Date: Apr. 14, 2016

(54) Plank and tile cutter incorporating scale means

(71) Applicants: Gregory J. Gundlach, Belleville, IL (US); Dennis R. Dickerson, Tilden, IL (US)

(72) Inventors: Gregory J. Gundlach, Belleville, IL (US); Dennis R. Dickerson, Tilden, IL (US)

(21) Appl. No.: 14/756,634

(22) Filed: Sep. 28, 2015

Related U.S. Application Data
(60) Provisional application No. 62/122,099, filed on Oct. 10, 2014.

(51) Int. Cl. B26D 7/01; B26D 1/08; B26D 5/16; B28D 1/22

(52) U.S. Cl. CPC B26D 7/016; B28D 1/225; B26D 1/085; B26D 5/16

(57) ABSTRACT

A plank and tile cutter incorporating a back gauge, the apparatus having a table incorporating a cutting blade for cutting tiles, operated through a pivotal and leveraged handle, cam operated, to forcefully lower the cutting blade into a cutting operation. The back gauge secures to the backside of the apparatus, and the gauge includes a scale to provide for precise measurement of the tile to be cut, and includes a guide that not only supports the backside of the tile to its precise dimension to be cut, but also furnishes support for the lead end of the tile during performance of the shearing function. The guide of the back gauge can be easily loosened, for resetting, simply by viewing its applied scale, and then refastened tightly to provide the guide for repeat cutting through the use of the cutter during application. Related types of side rails and angled guides may be provided upon the surface of the table, to further angulated cuts, as may be required.

### CROSS REFERENCE TO RELATED APPLICATION

This non-provisional patent application claims priority to the provisional patent application having Ser. No. 62/122,099 filed on Oct. 10, 2014.

### FIELD OF THE INVENTION

This invention relates to a plank and tile cutter that incorporates scale means, that adds to the precision of cutting of such flooring materials so as to facilitate the accuracy of performance of the flooring job, and provide prompt setting to achieve a cutting performance by the installer.

### BACKGROUND OF THE INVENTION

There are a myriad of tile and flooring type cutting devices that are available upon the market. Many of them relate or incorporate the use of a cutting blade, that functions as a shear means, to cut tile and other flooring during installation. Many of these cutters function upon the measure and scribe approach, where the tile may be marked as to where a cut should be made, as the essence of its effort to attain some accuracy in the cutting of such material for installation. Obviously, usually close tolerances are not met under such circumstances, since it is performed under the eye-ball approach when laying out the marking of the tile, and its location upon the cutter, for shearing.

As stated, there are numerous tile cutters that are available in the art. For example, U.S. Pat. No. 4,084,569, does show a tile cutter, which does incorporate a scale upon its frontal edge, which apparently allows for lateral adjustments to the tile as it is being set upon the cutter for shearing. The shown cutter is primarily used for cutting apparently ceramic tiles, and for even cutting glass, under the stress bending principle to snap the tile along an applied score line.

The patent to Yasuga, U.S. Pat. No. 6,223,736, shows another and related type of tile cutter. U.S. Pat. No. 6,240,914, to the same inventor, shows a related cutter.

U.S. Pat. No. 6,953,036, to Ishil, shows another tile cutter, operating upon the lever and guide rail principle for cutting a tile.

U.S. Pat. No. 6,935,544, shows a manual tile cutter. U.S. Pat. No. 6,269,994, shows a further manual tile cutter.

U.S. Pat. No. 6,148,810, shows a cutting/breaking apparatus, for generating a breaking force to sever ceramic tiles.

U.S. Pat. No. 5,560,274, shows a further manual tile cutter.

U.S. Pat. No. 5,505,359, shows a further tile cutter. This device, also, operates for use of a breaker head to crack a ceramic tile along a defined line.

U.S. Pat. No. 5,480,082, shows a further tile cutter.

Likewise, U.S. Pat. No. 4,378,782, shows a ceramic tile cutter that operates off the principle of applying a fracturing head to score and break a ceramic tile along a defined path.

U.S. Pat. No. 5,353,508, shows a border cutter for a strip of carpeting.

U.S. Pat. No. 4,262,418, shows a further boot for trimmer for resilient floor covering material, such as carpeting and linoleum.

The patent of Peterson, et al, U.S. Pat. No. 4,895,059, shows an adjustable back gauge support device for a, apparently, paper cutter.

Pat. No. D,303,074, shows a tile cutter incorporating a scale.

U.S. Pat. No. 5,169,045, shows a compass like scale used with a tile cutter. A similar type of scale means can be seen in U.S. Pat. No. 5,169,045. Likewise, U.S. Pat. No. 5,598,637, shows a scale applied for lateral measurements when cutting apparently ceramic tile. U.S. Pat. No. 5,012,441, shows a similar type of scale. Most of these scale means are applied to the platform of the tile cutter, in front of the cutter arrangement. U.S. Pat. No. 6,164,272, shows a related structure. The tile cutter shown in U.S. Pat. No. 6,223,736, shows the use of an adjustable scale means. U.S. Pat. No. 6,240,914, to the same inventor, shows a related cutter.

Pat. No. D,476,213, shows means for adjusting the cutting of a tile along an angular cut. The same can be said with respect to U.S. Pat. No. 6,708,686, showing a power glide tile cutter. Pat. No. D,536,945, shows a design for a tile cutter that also includes a scale means upon its cutting platform. U.S. Pat. No. 7,748,372, shows an adaptable tile-cutter apparatus for receiving disparately-sized tiles.

Other related types of tile cutters, mostly for cutting ceramic tiles, can be seen in U.S. Pat. No. 6,953,036, Pat. No. D,541,127, U.S. Pat. No. 6,935,544, U.S. Pat. No. 6,269,994, U.S. Pat. No. 5,560,274, U.S. Pat. No. 5,505,359, U.S. Pat. No. 5,303,690, and Pat. No. D,291,578.

The foregoing provides an analysis of the various prior art types of tile cutters that have been published in patents, some of them having scale means, but usually the scale means is applied upon the platform portion of the cutter, to allow for adjustment in the usually lateral length or angular positioning of the tile, during its cutting or cracking.

There are a variety of other types of cutting tools and flooring cutters that have previously been marketed. Some of them include a lever arm for operating a shear means for cutting laminates, pvc flooring, and the like. They do operate off of the concept of utilizing a lever against the force of compression springs for application of cams to force the shear into a cutting position at the frontal portion of their base structures. These are examples of the type of platform cutters that have been marketed in the art.

### SUMMARY OF THE INVENTION

This invention contemplates the formation of a tile cutter, having a scale means specifically arranged rearwardly of its cutting shear, and for use in providing for high accuracy in cutting of flooring such as resilient (vinyl) plank and tile, engineered hard wood and laminate, luxury vinyl tile, and even carpet tile, during its measurement, cutting, and installation. The concept of this invention is to provide for and facilitate the application of back gauges that may be applied to the tile cutter, to add precision to the cutting of the aforesaid tiles and flooring after measurement, in preparation for installation.

Essentially, the structure of this plank and tile cutter includes the usual platform, with a cam operating lever, that biases against the holder for the shear blade, which normally is elevated to provide clearance through the use of strong compression spring(s) such that when the lever is pivoted, causes downward movement to the shear blade, furnishing a cutting of such planks and tiles in preparation for installation. There is a scale means provided along one edge of the cutter platform, and an angulated means may be provided attaching to the scale means, so that the plank or tile to be cut can be measured for length, and even angular arrangements, in preparation for its cutting.

The essence of this invention is to add a back gauge to the apparatus, that can be finely set to provide for very precise cutting of the tile or plank, after being measured, for cutting and immediate installation. One or more such back gauges may be applied to the back end of the cutter platform, depending upon the size of tile being measured, for cutting, with adjustment means provided upon the back gauge, overlying its scale, to provide visual means for the installer to promptly set the gauge for positioning of the tile to be cut, at finite lengths, and holding the same in position, during a cutting operation.

It is, therefore, the principal object of this invention to provide a plank and tile cutter that provides convenient measurement of any tile to be cut, to precise dimensions, as required for the proper installation of flooring and related materials.

A further object of this invention is to provide a plank and tile cutter that facilitates the accurate cutting of resilient planks and tiles, engineered wood/laminate, vinyl tile, and carpet tiles, and other flooring materials during usage and installation.

Still another object of this invention is to provide scaling means that provides high accuracy in the measurement and cutting of such tiles during usage.

A further object of this invention is to provide a tile cutter that can be provided in multiple sizes, for cutting the 12 inch, 24 inch, and 36 inch wide tiles, and up to an approximate ⅝ inch thickness capacity.

A further object of this invention is to provide a precision steel blade for tile cutter that is replaceable. The replaceable steel blade cuts against a replaceable and reversible plastic anvil.

A primary object of this invention is to provide a plank and tile cutter that incorporates one or more back gauges that allows for cutting of repeatable lengths of flooring after measurement and setting.

A further object is to provide back gauges for a tile cutter that can be easily removed, and stored upon the underside of the apparatus, as during nonusage.

Still another object of this invention is to provide a cutting scale that can be mounted on either the right or left side of the cutting table and quickly secured in place by pins and knob screws.

Still another object of this invention is to provide a combination gauge that can be applied and used on either side of the cutting table of the apparatus.

Still another object of this invention is to provide a tile'cutter which has a handle that can mount to either the right or left side of the cutter.

Another object of this invention is to provide an extendible handle for the tile cutter that provides adequate leverage and can be applied using two hands as for use for hard to cut materials like carpet tile.

A further object is to provide a U shaped handle for a tile cutter that also can be grasped by two hands for furnishing additional force to the cutting action when severing flooring.

These and other objects may become more apparent to those skilled in the art upon review of the summary of the invention as provided herein, and upon undertaking a study of the description of its preferred embodiments, in view of the drawings.

### BRIEF DESCRIPTION OF THE DRAWINGS

In referring to the drawings,

FIG. 1 shows the plank and tile cutter of this invention with its back gauge installed for usage;

FIG. 2 shows the plank and tile cutter of this invention, with the back gauge during its assembly;

FIG. 2A is a back view;

FIG. 3 shows an isometrical oblique view disclosing the back gauge being fully connected to the cutting table;

FIG. 4 provides an exploded view of the back gauge, its assembly means, and the gauge dimensional stop and support for the plank or tile being cut; and

FIG. 5 shows an isometrical oblique view from the rear, showing a substantially widened cutter platform, for cutting wider flooring, with the U shaped operational handle, and showing at least one of the back gauges being installed in preparation for usage.

### DESCRIPTION OF THE PREFERRED EMBODIMENT

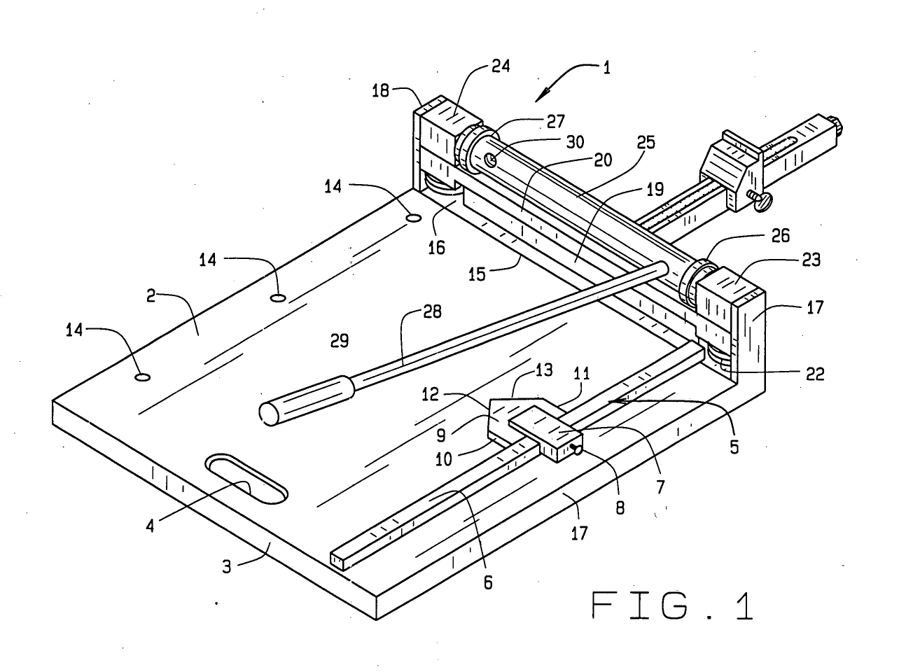

In referring to the drawings, and in particular FIG. 1, the plank and tile cutter 1 of this invention is readily disclosed. It includes a table or platform 2 mounted upon a base 3 to furnish a substantially stable surface upon which the tile or planks may locate, in preparation for a cutting operation. The top surface may be formed of a hard polymer. A slot for handle hold, as at 4, is provided for convenience of its conveyance.

Provided mounted on one side of the table is a lateral guide 5 which may contain a scale 6 upon its upper surface, and mounts a slide block 7 that may be slide along the scale when positioning it for holding of a plank or tile in place, in preparation for a cutting operation. A thumb screw 8 is furnished for securing the guide block to the side rail 5. The guide block also may mount an angulated member 9 which may contain transverse surfaces, as at 10 and 11, in addition to angulated surfaces 12 and 13, provided for positioning any tile along an angle, such as at a 45° angle, or other angles that may be provided upon the guide, when an angulated cut is required for the tile being prepared for installation.

The guide rail 5 may be secured from underneath of the table, by fasteners (not shown) as can be understood. As can be noted on the left side of the table, there are a series of additional apertures, as at 14, and these are provide for securement through fasteners of the guide rail 5, to the left side of the table, where that is required for cutting of other planks or tiles during usage.

The base 3 has a forward end, as at 15, and secured therewith is the cutter base 16 which secures with the back end of the table. Side walls 17 and 18 are provided at the sides and back end of the table, and may be secured with the cutter base 15, or may be integrally formed with the base 3, as can be understood. The side walls mount the cutter blade 19 and the blade supporting structure 20 for a vertical shifting between the side walls 17 and 18, and the blade and its supporting structure 20 are secured for vertical shifting upon pins extending rigidly upwardly from the base 15, and contained within the compression springs 21 and 22 as can be understood. Cam supporting structures 23 and 24 are secured to the side walls 17 and 18, respectively, and these supports mount for pivotal movement the cam supporting rod 25 and its spaced cams 26 and 27. A leveraged handle 28 incorporating a length of grip 29 is secured into the cam rod 25, such that when it is pivoted, through downward pressure exerted upon the rod 28, it turns the cams 26 and 27, which bias against the blade support 20, forcing the blade 19 downwardly for cutting any tile that may be arranged adjacent the back edge 16 of the table. When released, the compression springs force the hand and cams upward, raising the cutter blade 19, after a cutting procedure has been performed. It can also be seen that there is a threaded aperture 30 provided to the other side of the cam bar, and the handle can be threadedly engaged therein, to provide for left handed operation of the apparatus. Also, the handle may be formed as telescopic tubes, to provide for its extension to add further leverage to the handle during usage.

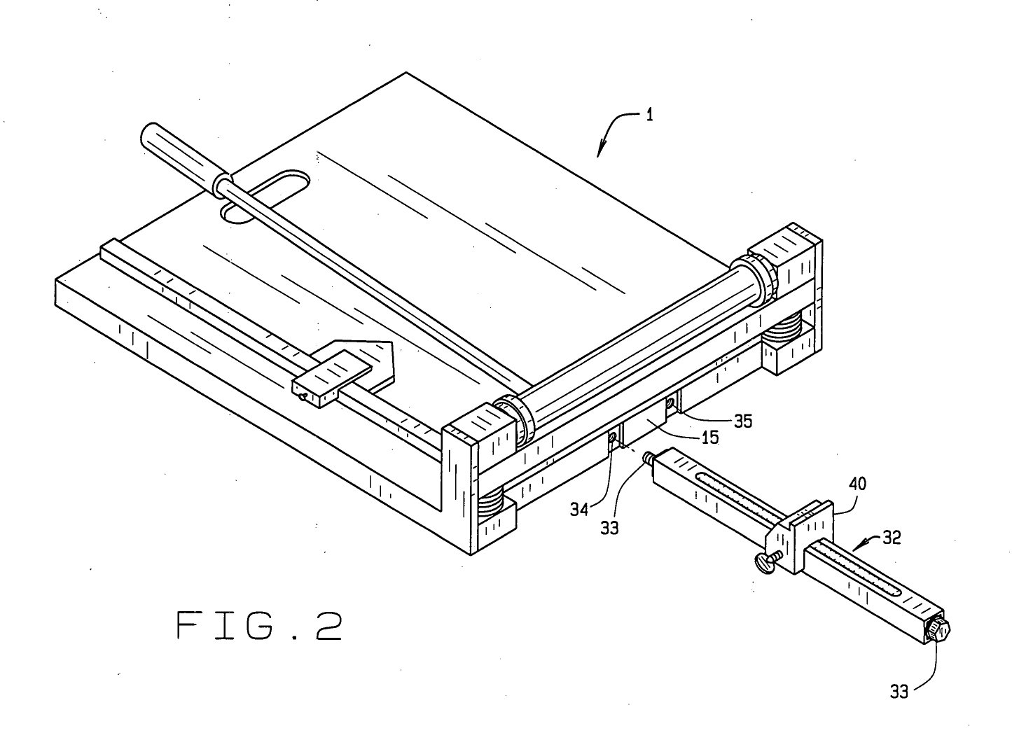

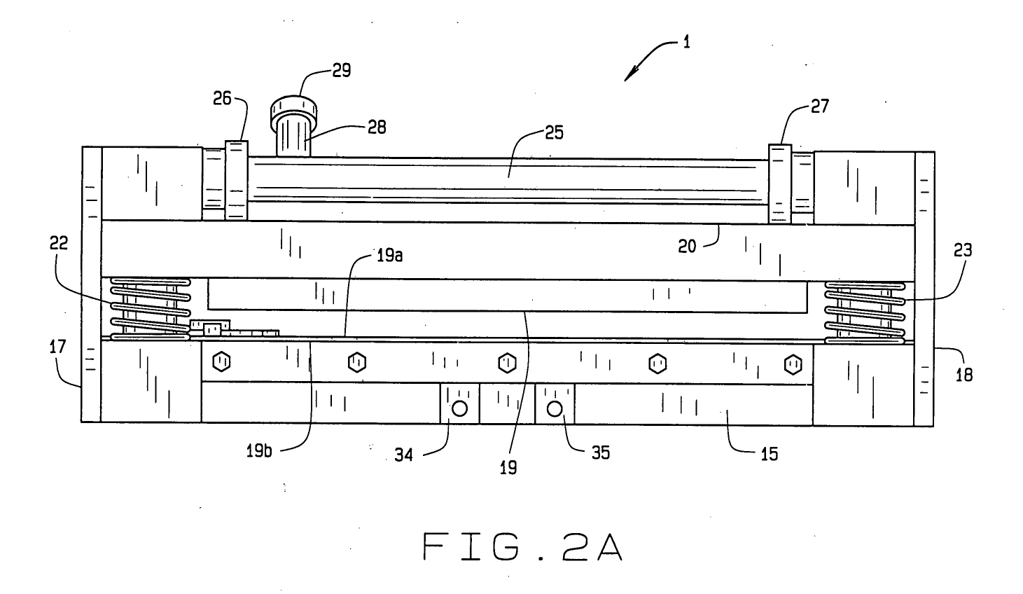

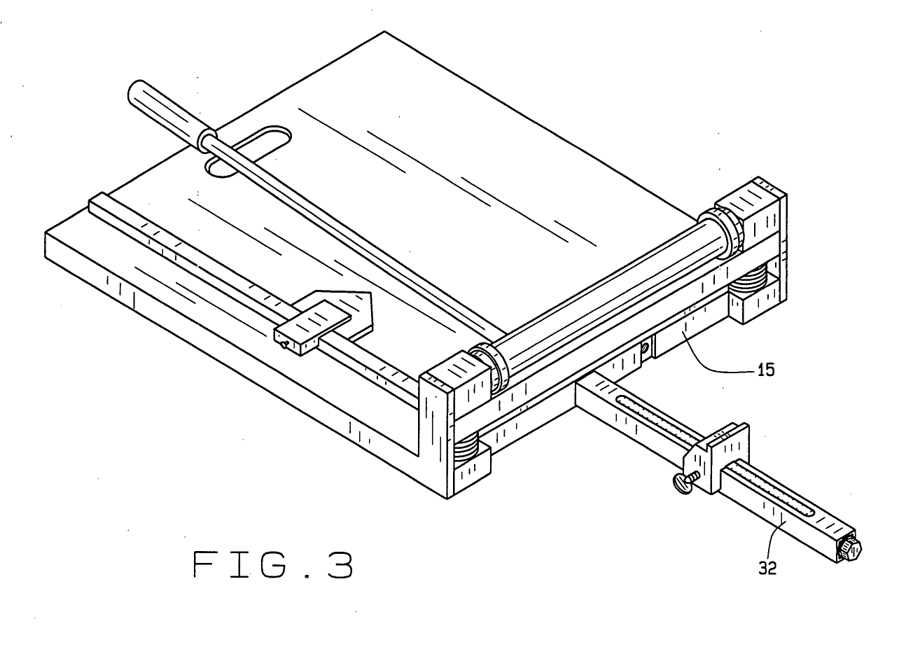

FIG. 2 shows an oblique back view of the apparatus 1. As noted, it includes the back gauge 32 which may be threaded or otherwise engaged to the back 15 of the table, either by threadedly engaging through its lengthy fastener 33 for bolting into its threaded aperture 34, as can be seen. The back gauge may be located to the right side of the table, as noted in FIG. 3, or it may threaded or otherwise engage into the threaded aperture 35 as required for the cutting operation to be performed.

The cutting blade 19, as previously reviewed, actually encounters the upper surface of a cutter base, as at 19a, during a cutting operation. Usually the material for this base is a hard polymer, that can cooperate with the sharp edge . of the cutting blade 19, to provide a complete severing of the plank or tile, during performance of a cutting operation. The cutter base is bolted in place through a fastened bar 19b.

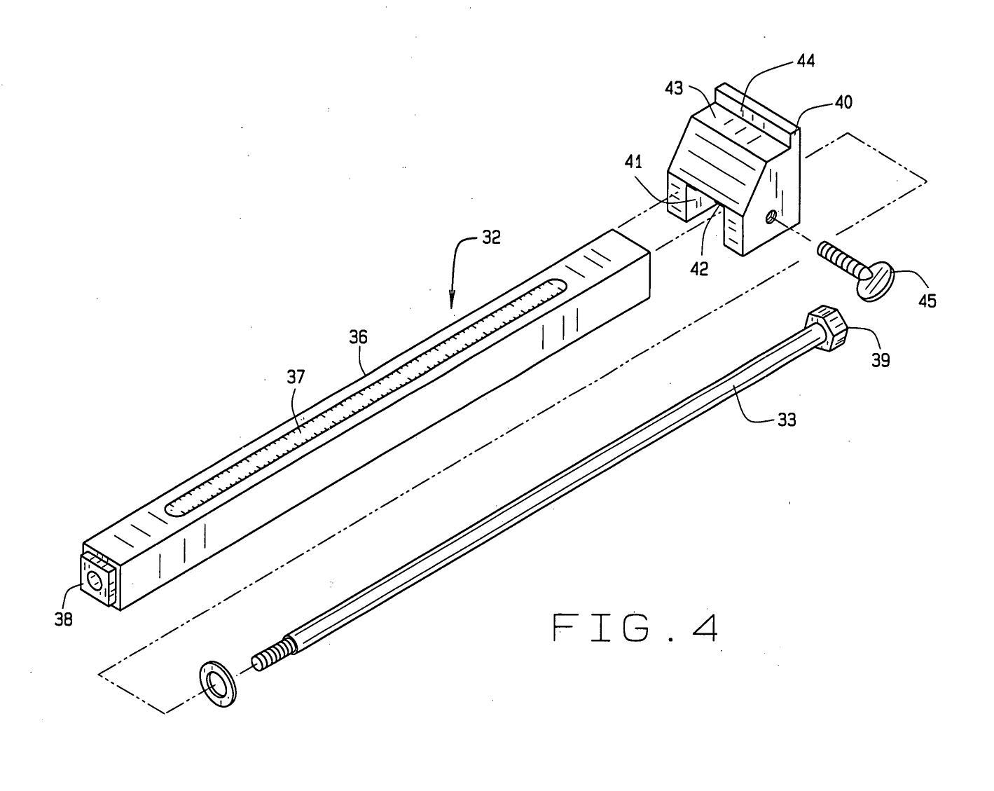

More specifically, the back gauge 32 can be seen in FIG. 4. It includes a length of tubing, as at 36 and includes an accurate scale 37 upon its surface, so that when the plank or tile locates underneath the cutter blade, during its locating, the exact amount of its cutoff segment can be accurately measured upon the scale, in preparation for a cutting operation. The length of rod 33 extends through the scale tube 36, extends out of its proximate end 38, and is threadedly engaged within one of the apertures 34 or 35, at the back end of the table. The multi faceted bolt head, as at 39, can be tightened through the use of a wrench for prompt securement of the scale tube 36 firmly in place.

A guide 40 is provided for locating upon the scale tube 36, the guide having sufficient clearance at its cutout portion 41 to conveniently ride upon the surface of the tube 36, and align its frontal edge 42 upon the scale, for measurement purposes. The guide includes an upwardly cutout portion 43 upon which any plank or tile is slid for location, until it comes to rest against its back surface 44 in preparation for a cutting operation to a precise dimension. The surface 43 provides further support for the plank or tile in preparation for its cutting, aligned with the upper surface of the table 2, and in addition, the back face 44 of this cutout portion furnishes the limits for extending the plank through the cutter, under its blade, in preparation for cutting. once the guide is adjusted and set upon the scale 37. For example, if a 4 inch cut is to be made, the frontal edge 42 is arranged at the 4 inch position, the thumb screw 45 of the guide is tightened, so that when the plank or tile is slid upon the surface of the table, rearwardly, under the clearance provided by the raised cutter blade, it can be slid into position upon the surfaces 43 and against 44 so that the installer will know that the precise 4 inch cut is being made from the tile, when the cutter blade is moved downwardly by pivoting of the handle 28. Thus, if repeat cuttings of tile are required to remove that 4 inch dimension from its back edge, then tiles may be repeatedly slid upon the table, onto the guide 40, immediately cut, so as to provide the number of cut tiles required for completion of that segment of the flooring installation. Actually, two back gauges could be applied to both segments 34 and 35 to add further support and accuracy during cutting.

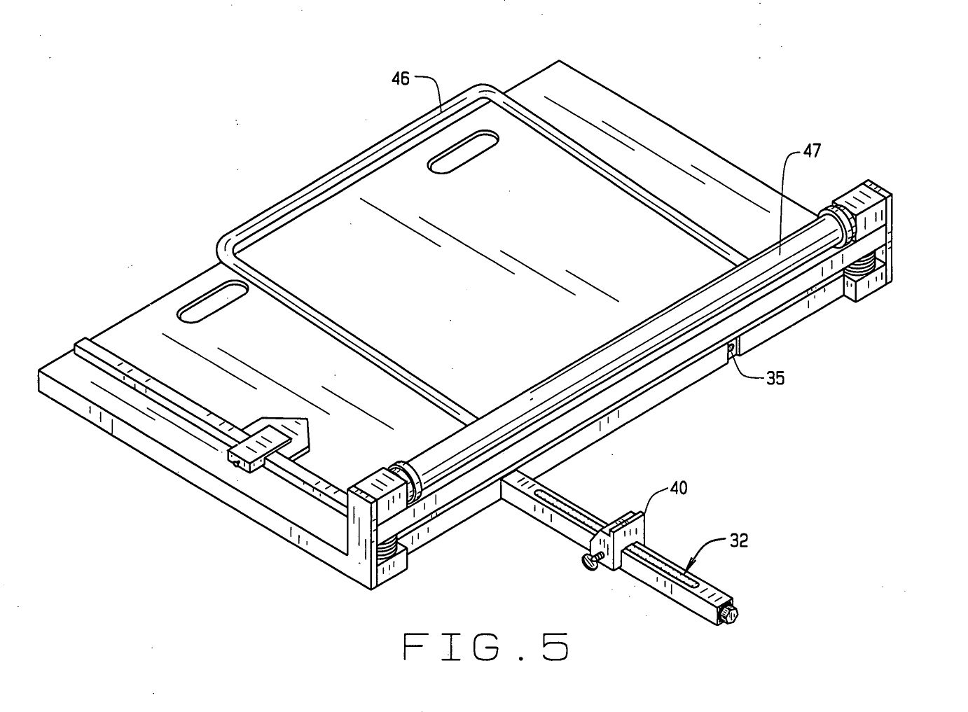

As previously reviewed, and as can be noted in FIG. 5, the apparatus may include means for providing for cutting of substantially wider planks or tiles. In this particular instance, the table is significantly wider than that as shown for the cutter table of FIG. 1, and as previously explained. In this instance, a U shaped handle 46 is furnished, and secures to the cam bar 47 by any type of fastening, so that a two handed operation may be used for lowering the handle 46, to perform a cutting operation, as previously explained. One or more of the back gauges 32 may also be furnished, and can locate at the position as shown in FIG. 5, or it may locate within a second threaded aperture, such as 35, or to both locations, as previously explained, to provide that back measurement for the tile to be cut, through the adjustment and setting of its gauge 40, and furnish full support as previously explained. All of the other components of this cutting apparatus are relatively similar to that as previously explained, as can be understood.

Variations or modifications to the subject matter of this invention may occur to those skilled in the art upon review of the invention as provided herein. Such variations, if within the spirit of this invention, are intended to be encompassed within the scope of any claims to patent protection issuing hereon. The description of the invention in the preferred embodiment, and the disclosure of the apparatus in the drawings, are primarily set forth for illustrative purposes only.

I claim:

1. A tile cutter for cutting flooring material, comprising a table, said table having a cutting blade provided proximate its back end, a cam rod operatively associated with the cutting blade, a leveraged handle provided upon the cam rod, which when pivoted, lowers the cutting blade towards the table to provide for cutting of any flooring material thereunder, a back gauge connected with the backside of the table, the back gauge having an adjustable guide, which can be adjusted to precise dimensions, and against which the back edge of any flooring material encounters during a setting in preparation for performance of a precise cutting operation.

2. The cutter for flooring material of claim 1, wherein a guide is provided slidable upon the back gauge to provide for adjusted settings in the dimensions of the material to be cut.

3. The cutter for flooring material of claim 2, wherein said guide includes a support surface upon which the back edge of the material to be cut is rested, to provide support for said flooring material during a cutting operation.

4. The cutter for flooring material of claim 3, and including a fastener for securement of the guide to the back gauge during its adjusted setting.

5. The cutter for flooring material of claim 4, wherein the means for fastening the guide to the back gauge includes an adjustable thumb screw.

6. The cutter for flooring material of claim 1, wherein said table having a width to accommodate a flooring material to be cut of a predetermined width.

7. The cutter for flooring material of claim 6, wherein said table has a wider width for accommodating of flooring material of substantially wider dimension.

8. The cutter for flooring material of claim 3, wherein said guide includes a back face against which the leading edge of any flooring material to be cut encounters to provide a precise fixed dimension for cutting of any material.

9. The cutter for flooring material of claim 1, wherein the handle is a linear length of handle for pivoting the cam rod and lowering the cutting blade during a shearing function.

10. The cutter for flooring material of claim 9 wherein said handle is telescopically fixed to provide for the extension to obtain greater leverage during a cutting function.

11. The cutter for flooring material of claim 1, wherein said handle is a U shaped handle, provided for accommodating a two handed pivoting of the handle during performance of a cutting function.

12. The cutter for flooring material of claim 8 wherein said guide includes a support surface upon which the leading edge of any tile to the cut is supported in preparation for a cutting operation.
